(19) United States
(12) Patent Application Publication
(10) Pub. No.: US 2017/0006199 A1
(43) Pub. Date: Jan. 5, 2017

(54) IMAGING APPARATUS AND PROJECTION APPARATUS

(71) Applicant: CANON KABUSHIKI KAISHA, Tokyo (JP)

(72) Inventor: Keiichiro Ishihara, Ageo-shi (JP)

(21) Appl. No.: 15/189,942

(22) Filed: Jun. 22, 2016

(30) Foreign Application Priority Data
Jun. 30, 2015 (JP) 2015-132144

(51) Int. Cl. H04N 5/225; G03B 21/14; G02B 6/08

(52) U.S. Cl. CPC H04N 5/2254; G02B 6/08; G03B 21/147

(57) ABSTRACT

Provided is an imaging apparatus, including: an imaging optical system which forms an optical image of an object; and a plurality of image pickup units which capture the optical image of the object, in which each of the plurality of image pickup units has an image sensor and a light guide body which includes a plurality of optical waveguide members transmitting light from the imaging optical system to the image sensor, an angle of a central axis of each of two adjacent image pickup units with respect to an optical axis of the imaging optical system is mutually different, and an optical image transmission distance of each of the two adjacent image pickup units is mutually different.

### BACKGROUND OF THE INVENTION

Field of the Invention

The present invention relates to an imaging apparatus and a projection apparatus.

Description of the Related Art

An imaging apparatus including an optical image transmitter (light guide body) which has a plurality of optical waveguides (optical waveguide members) such as optical fibers has been known. In such an imaging apparatus, an optical image formed by an imaging optical system is captured by an image sensor via a plurality of optical image transmitters.

Japanese Patent Laid-Open No. 558-100106A discloses an imaging apparatus in which, in order to correct curvature on a focal surface, which is generated due to a wider angle of an optical system of a radiometer, optical fibers and image sensors are arranged along the curvature on the focal surface. Further, Japanese Patent Laid-Open No. 2003-283906 discloses an imaging apparatus which transmits an optical image formed by an imaging optical system to a plurality of image sensors by a plurality of optical fiber bundles.

However, in the imaging apparatuses of Japanese Patent Laid-Open No. S58-100106A and Japanese Patent Laid-Open No. 2003-283906, long optical fibers are adopted in order to prevent interference between the image sensors, and it is therefore difficult to reduce a space in which the optical fibers and the image sensors are arranged.

### SUMMARY OF THE INVENTION

In an imaging apparatus having a plurality of image pickup units each of which includes a light guide body and an image sensor, the invention reduces a space in which the plurality of image pickup units are arranged compared with a conventional one.

One aspect of the invention is an imaging apparatus, including: an imaging optical system which forms an optical image of an object; and a plurality of image pickup units which capture the optical image of the object, in which each of the plurality of image pickup units has an image sensor and a light guide body which includes a plurality of optical waveguide members transmitting light from the imaging optical system to the image sensor, an angle of a central axis of each of two adjacent image pickup units with respect to an optical axis of the imaging optical system is mutually different, and an optical image transmission distance of each of the two adjacent image pickup units is mutually different.

Further features of the present invention will become apparent from the following description of exemplary embodiments with reference to the attached drawings.

### BRIEF DESCRIPTION OF THE DRAWINGS

FIG. 1 is a schematic view for explaining a configuration of an imaging apparatus of an exemplary embodiment and Embodiment 1.

FIGS. 2A and 2B are schematic views for explaining configurations of image pickup units of the exemplary embodiment and Embodiment 1.

FIGS. 3A and 3B are schematic views for explaining the configurations of the image pickup units of Embodiment 1.

FIG. 4 is a schematic view for explaining a configuration of image pickup units of Comparative Example.

FIG. 5 is a schematic view for explaining arrangement of the image pickup units of Embodiment 1.

FIG. 6 is a schematic view for explaining a configuration of an imaging apparatus of Embodiment 2.

FIGS. 7A and 7B are schematic views for explaining configurations of optical image transmitters of Embodiment 2.

FIGS. 8A to 8C are schematic views for explaining a configuration and arrangement of an imaging apparatus of Embodiment 3.

FIG. 9 is a schematic view for explaining a configuration of an imaging apparatus of Embodiment 4.

FIG. 10 is a schematic view for explaining a configuration of a projection apparatus of Embodiment 5.

### DESCRIPTION OF THE EMBODIMENTS

### Exemplary Embodiment

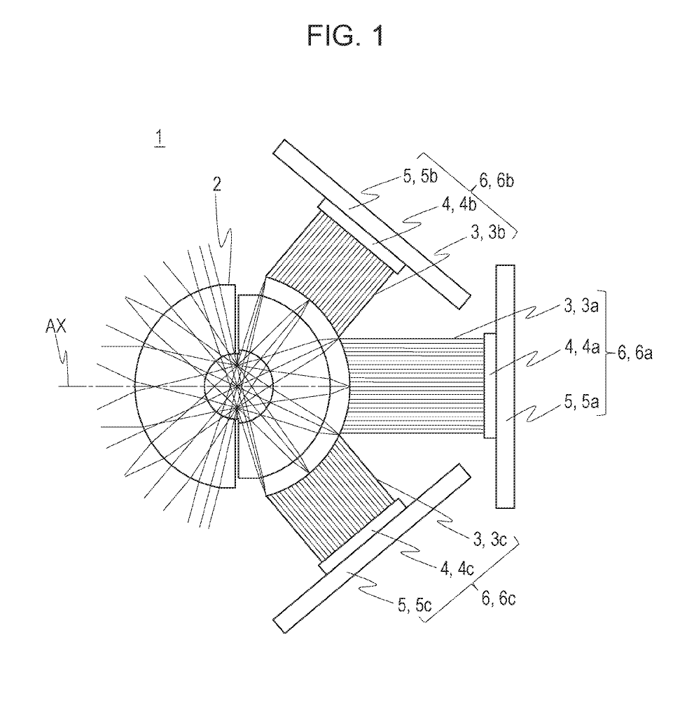

An imaging apparatus 1 of the present exemplary embodiment will be described with reference to FIG. 1. FIG. 1 is a schematic view for explaining a configuration of the imaging apparatus 1.

The imaging apparatus 1 has an imaging optical system (image-forming optical system) 2 and three image pickup units 6. Each of the plurality of image pickup units 6 includes an optical image transmitter (light guide body) 3, a sensor 4 which is an image sensor, and a driving substrate 5. In description below, the respective image pickup units 6 are called a first image pickup unit 6a, a second image pickup unit 6b, and a third image pickup unit 6c, in some cases. The image pickup unit 6a includes an optical image transmitter 3a, a sensor 4a which is an image sensor, and a driving substrate 5a. The image pickup unit 6b includes an optical image transmitter 3b, a sensor 4b which is an image sensor, and a driving substrate 5b. The image pickup unit 6c includes an optical image transmitter 3c, a sensor 4c which is an image sensor, and a driving substrate 5c.

The imaging optical system 2 is a ball lens which forms an optical image of an object to form an image surface (optical image of the object) 21. The optical image formed by the imaging optical system 2 has a spherical shape whose concave surface faces the imaging optical system 2.

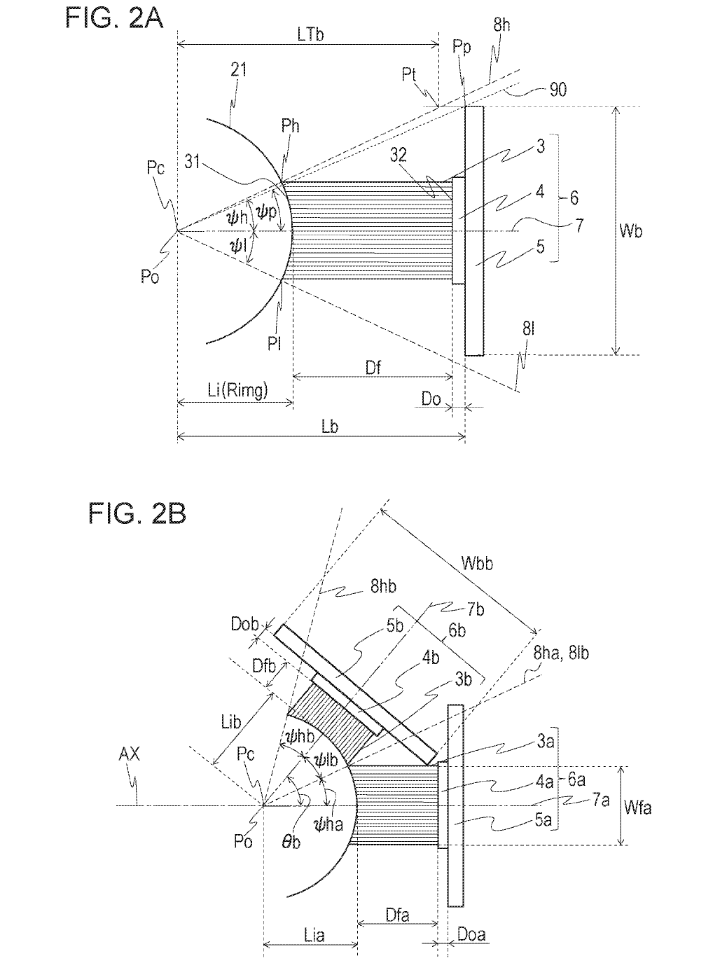

A configuration of the image pickup unit 6 will be described more specifically with reference to FIG. 2A. FIG. 2A is a schematic view for explaining the configuration of the image pickup unit 6. The image pickup unit 6 is arranged so that the centers of the optical fiber bundle 3, the image sensor 4, and the driving substrate 5 are on a central axis 7. The central axis 7 is a surface normal of an incident surface 31 in the center (center of gravity) of a region to be captured by the image pickup unit 6, i.e. the center of gravity of the incident surface 31 of the optical fiber bundle 3. Respective central axes of two adjacent image pickup units 6 have mutually different angles (inclinations) with respect to an optical axis AX.

The optical image transmitter 3 is an optical fiber bundle having a plurality of optical fibers which are optical waveguides. Each of three optical fiber bundles 3 has a plurality of optical fibers of a straight type. In the optical fiber of the straight type, a diameter of an incident surface and a diameter of an emitting surface are the same. The respective incident surfaces 31 of the three optical fiber bundles 3 are arranged with no gap therebetween so as to be arranged along the image surface 21. That is, a surface formed by uniting the incident surfaces 31 is a surface including the image surface 21. By setting the center of curvature Pc of the image surface 21 as the original point Po, the plurality of image pickup units 6 are arranged by being rotated around the original point Po.

The sensors 4 are arranged so as to respectively adhere closely to the optical fiber bundles 3. In this manner, the imaging apparatus 1 of the present exemplary embodiment acquires an image having a super wide angle and high resolution by dividing an optical image formed on the image surface 21 by the imaging optical system 2 into three and capturing images of the respective regions by the three image pickup units 6. By capturing images in the divided manner, it is possible to obtain an image having a high image quality. Moreover, it is possible to reduce the number of pixels of each of the sensors 4, thus making it possible to improve a yield at a time of manufacturing the sensors 4.

The driving substrate 5 is arranged on a side of the image sensor 4, which is opposite to the side of the imaging optical system 2. Interconnection and a circuit of the image sensor 4 are arranged on the driving substrate 5. Therefore, a size of the driving substrate 5 has a restriction, and is larger than that of the image sensor 4 generally. In a case where a plurality of image pickup units 6 are arranged, it is necessary to arrange them with the sizes of the driving substrates 5 taken into consideration.

Hereinafter, definitions of words used in the present specification will be described with reference to FIG. 2A. The incident surface 31 of the optical fiber bundle 3 has two end points. One end (upper end) of the end points is Ph, the opposite end (lower end) is Pl, and lines obtained by connecting the original point Po (center of curvature Pc of the image surface 21) and the end points Ph and P1 are region boundary lines 8h and 8l, respectively. Moreover, angles formed by the central axis 7 of the image pickup unit 6 and the region boundary lines 8h and 8l are region boundary angles Ψh and Ψl, respectively.

Among members included in the image pickup unit 6, a member which causes physical interference with the other members of the image pickup unit 6 most easily is called a largest member. The largest member is a member which includes a point Pp with which an angle Ψp formed between a straight line 90, which is obtained by connecting the certain point Pp on the member included in the image pickup unit 6 and the original point Po, and the central axis 7 becomes the maximum. In the present exemplary embodiment, the driving substrate 5 is the largest member. That is, a width of the largest member is also able to be referred to as the maximum width of the image pickup unit 6.

When a straight line parallel to the central axis 7 of the image pickup unit 6 is drawn from the point Pp with which the angle Ψp becomes the maximum, an intersection point of the straight line and the region boundary line 8h or 8l is Pt. In this case, a distance from the original point Po of the image pickup unit 6 to the intersection point Pt in a central axis direction (direction of the central axis 7) is defined as a largest member threshold LTb.

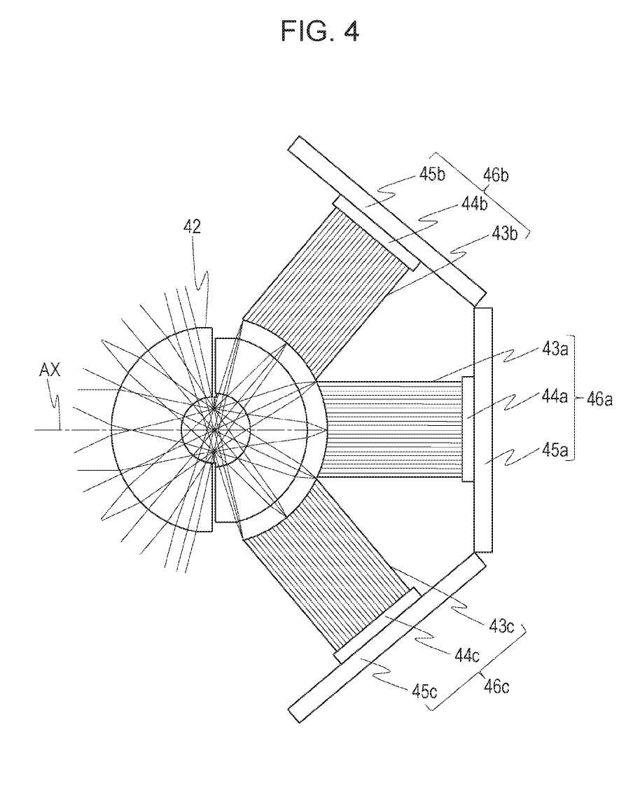

In a conventional imaging apparatus, optical fiber bundles each of which passes through the central axis of an image pickup unit have equal lengths as illustrated in FIG. 4. Alternatively, by setting each of the lengths of the optical fiber bundles of the image pickup units to be long, all members constituting each of the image pickup units are arranged so as to be accommodated between the region boundary lines 8h and 8l. In the case of this configuration, in order to minimize a space in which the plurality of image pickup units are arranged, each of the image pickup units is arranged so that the end point Pp of the largest member thereof is in contact with the region boundary line 8h or 8l. In a case where the largest member extends beyond the region boundary line 8h or 8l, the largest member of each of the image pickup units physically interferes with a member of a different image pickup unit.

On the other hand, in the present exemplary embodiment, it is set that at least one of the plurality of image pickup units 6 is arranged so as to extend beyond the region boundary lines 8h and 8l. At this time, it is desirable that a length of the optical fiber bundle 3 (optical image transmission distance) is changed in order to change a position at which each member of the image pickup unit 6 is arranged. The optical image transmission distance will be described below.

Note that, the “optical image transmission distance” in the present specification is defined as a length of the optical fiber bundle 3 on the surface normal of the incident surface 31 in the center of gravity of the incident surface 31 of the optical fiber bundle 3. The “optical image transmission distance” will be hereinafter called the “length of the optical fiber bundle (optical waveguide member)” in some cases, both of which are synonymous. In the present exemplary embodiment, the optical image transmission distance is the length of the optical fiber bundle 3 of the optical fiber (optical waveguide member), which transmits light from the center of gravity of the incident surface 31 of the optical fiber bundle 3, in the direction of the central axis 7 of the image pickup unit 6.

The shortest optical image transmission distance with which the largest member 5 is able to be accommodated between the region boundary lines 8h and 8l is called the largest member threshold LTb. When the width of the largest member 5 (maximum width of the image pickup unit 6) in a direction perpendicular to the central axis 7 is Wb, the largest member threshold LTb is expressed with a formula (4).

$$LTb = \frac{Wb}{tan ( \vert ψ h \vert ) + tan ( \vert ψ l \vert )} \qquad ( 4 )$$

In this manner, the largest member threshold LTb is decided in accordance with the width Wb of the largest member 5 and the region boundary angles Ψh and Ψl.

In addition, a distance Lb between the original point Po and the largest member 5 in the direction parallel to the central axis 7 is expressed with a formula (5) below. Note that, a distance from the original point Po to the incident surface 31 of the optical fiber bundle 3 in the direction of the central axis 7 is Li, the length of the optical fiber bundle 3 (optical image transmission distance) is Df, and a distance from the largest member 5 to an emitting surface 32 of the optical fiber bundle 3 in the direction of the central axis 7 is Do, and the distance Li is the same as a curvature radius Rimg of the image surface 21.

Lb=Li+Df+Do (5)

In this case, an item whose length is able to be changed positively is the length Df of the optical fiber bundle 3. That is, by changing the length Df of the optical fiber bundle 3, it is possible to change the position at which each member of the image pickup unit 6 is arranged. In the present exemplary embodiment, it is set that optical fiber bundles 3 of adjacent image pickup units 6 have different lengths Df. At this time, the length Df of the optical fiber bundle 3 of at least one of the image pickup units 6 is set to be shorter than a predetermined length.

According to the formula (5), a length (optical image transmitter threshold) DTf of the optical fiber bundle 3 in a case where the distance Lb becomes the largest member threshold LTb is expressed with a formula (6).

DTf=LTb−Li−Do (6)

As above, when Df<DTf, that is, in a case where a formula (1) is satisfied, the largest member 5 of the image pickup unit 6 is to extend beyond the region boundary lines 8h and 8l and not to be accommodated between the region boundary lines 8h and 8l.

$$Df < \frac{Wb}{tan ( \vert ψ h \vert ) + tan ( \vert ψ l \vert )} - Li - Do \qquad ( 1 )$$

In the present exemplary embodiment, it is set that optical fiber bundles 3 of adjacent image pickup units 6 have different lengths Df. At this time, the length Df of the optical fiber bundle 3 of at least one of the adjacent image pickup units 6 is set so that the formula (4) is satisfied.

The length Df of the optical fiber bundle 3 will be described more specifically with reference to FIG. 2B by taking the first image pickup unit 6a and the second image pickup unit 6b as an example. FIG. 2B is a schematic view illustrating one example of configurations of the first image pickup unit 6a and the second image pickup unit 6b.

A length of the optical fiber bundle 3a of the first image pickup unit 6a is different from a length of the optical fiber bundle 3b of the second image pickup unit 6b which is adjacent to the first image pickup unit 6a, and the length of the optical fiber bundle 3b is shorter. Note that, the length of the optical fiber bundle 3a of the first image pickup unit 6a is also different from a length of the optical fiber bundle 3c of the third image pickup unit 6c, and the length of the optical fiber bundle 3c is shorter.

At this time, as to the first image pickup unit 6a, it is set that a distance from the original point Po to an incident surface 31a of the optical fiber bundle 3a in a direction of a central axis 7a is Lia, the length of the optical fiber bundle 3a is Dfa, a distance from a largest member 5a to an emitting surface 32a of the optical fiber bundle 3a in the direction of the central axis 7a is Doa, and a width of the optical fiber bundle 3a is Wfa. In addition, as to the second image pickup unit 6b, it is set that a distance from the original point Po to an incident surface 31b of the optical fiber bundle 3b in a direction of a central axis 7b is Lib, the length of the optical fiber bundle 3b is Dfb, and a distance from a largest member 5b to an emitting surface 32b of the optical fiber bundle 3b in the direction of the central axis 7b is Dob.

It is desirable that the length Dfb of the optical fiber bundle 3b of the second image pickup unit 6b whose optical image transmission distance is short satisfies a formula (2). When the formula (2) is satisfied, each member of the second image pickup unit 6b does not physically interfere with the optical fiber bundle 3a of the adjacent first image pickup unit 6a. It is set here that an angle (rotation angle) formed between the central axis 7b of the second image pickup unit 6b and the optical axis AX of the imaging optical system 2 is θb, a width of the largest member 5b of the second image pickup unit 6b is Wbb, and region boundary angles of the second image pickup units 6b are Ψhb and Ψld.

$$\frac{Wbb}{2 \times tan θ b} + \frac{Wfa}{2 \times sin θ b} - Lib - Dob < Dfb < \frac{Wbb}{tan ( \vert ψ hb \vert ) + tan ( \vert ψ lb \vert )} - Lib - Dob \qquad ( 2 )$$

Though the length Dfa of the optical fiber bundle 3a of the first image pickup unit 6a whose optical image transmission distance is longer may be equal to or more than an optical image transmitter threshold DTfa, in order to further reduce a space for arrangement, it is desirable that the formula (1) is satisfied. In this case, a formula (3) is desired to be satisfied. In a case where the formula (3) is satisfied, it is possible to reduce physical interference of each member of the first image pickup unit 6a with each member of the second image pickup unit 6b. In this case, a region boundary angle of the first image pickup unit 6a on a second image pickup unit side (side of the second image pickup unit 6b) is Ψha.

$$\frac{Lib + Dfb + Dob}{cos θ b} - \frac{Wfa \times tan θ b}{2} - Lia < Dfa \leq \frac{Wfa}{2 \times tan ( \vert ψ ha \vert )} - Lia - Doa \qquad ( 3 )$$

Moreover, it can also be configured that one of optical image transmission distances of adjacent image pickup units is set to be shorter than the optical image transmitter threshold DTf and the other is set to be longer than the optical image transmitter threshold DTf.

Further, the optical image transmission distance Df of an image pickup unit having the greatest rotation angle θ can be set to be shorter than a length of an optical fiber bundle of an adjacent image pickup unit. A space of a corner part of the imaging apparatus 1 is thereby reduced, thus making it possible to effectively miniaturize the imaging apparatus 1. When the number of image pickup units 6 which are arrayed in any directions is an odd number, it is possible to increase the number of image pickup units 6 whose optical image transmission distances Df are short.

With the configuration as above, in an imaging apparatus having a plurality of image pickup units, it is possible to reduce a space in which the image pickup units are arranged compared with a conventional one. In addition, since it is possible to shorten a length of each optical fiber to be used compared with a case where all of the lengths of the optical fiber bundles 3a, 3b, and 3c are set to be the same, it is possible to achieve a reduction in costs by manufacturing the optical fiber bundles at a moderate price.

### Embodiment 1

An imaging apparatus of the present embodiment has a configuration similar to that of the imaging apparatus 1 of the first exemplary embodiment. The imaging optical system 2 has a super wide view angle whose maximum view angle is ±75 deg, and forms an optical image of an object on the image surface 21. Configurations of the respective image pickup units 6a, 6b, and 6c are indicated in Table 1.

TABLE 1

| | | | | |
|---|---|---|---|---|
| Imaging | Focal distance | f | 10.0 | mm |
| optical | Curvature radius of image surface | Rimg | 10.0 | mm |
| system | | | | |
| First | Distance from original point of image | Lia | 10.0 | mm |
| image | pickup unit to incident surface of optical | | | |
| pickup | image transmitter | | | |
| unit | Rotation angle of image pickup unit | θa | 0.0 | deg |
| | Width of largest member | Wba | 21.0 | mm |
| | Width of optical image transmitter | Wfa | 9.3 | mm |
| | Region boundary angle (upper end) | ψha | +25.0 | deg |
| | Region boundary angle (lower end) | ψla | −25.0 | deg |
| | Largest member distance threshold | LTba | 22.5 | mm |
| | Largest member distance | Lba | 23.0 | mm |
| | Distance from largest member to emitting | Doa | 1.0 | mm |
| | surface of optical image transmitter | | | |
| | Threshold of full length of optical image | DTfa | 11.5 | mm |
| | transmitter | | | |
| | Full length of optical image transmitter | Dfa | 12.0 | mm |
| Second | Distance from original point of image | Lib | 10.0 | mm |
| image | pickup unit to incident surface of optical | | | |
| pickup | image transmitter | | | |
| unit | Rotation angle of image pickup unit | θb | +50.0 | deg |
| | Width of largest member | Wbb | 21.0 | mm |
| | Width of optical image transmitter | Wfb | 9.3 | mm |
| | Region boundary angle (upper end) | ψhb | +25.0 | deg |
| | Region boundary angle (lower end) | ψlb | −25.0 | deg |
| | Largest member distance threshold | LTbb | 22.5 | mm |
| | Largest member distance | Lbb | 17.7 | mm |
| | Distance from largest member to emitting | Dob | 1.0 | mm |
| | surface of optical image transmitter | | | |
| | Threshold of full length of optical image | DTfb | 11.5 | mm |
| | transmitter | | | |
| | Full length of optical image transmitter | Dfb | 6.7 | mm |
| Third | Distance from original point of image | Lic | 10.0 | mm |
| image | pickup unit to incident surface of optical | | | |
| pickup | image transmitter | | | |
| unit | Rotation angle of image pickup unit | θc | −50.0 | deg |
| | Width of largest member | Wbc | 21.0 | mm |
| | Width of optical image transmitter | Wfc | 9.3 | mm |
| | Region boundary angle (upper end) | ψhc | +25.0 | deg |
| | Region boundary angle (lower end) | ψlc | −25.0 | deg |
| | Largest member distance threshold | LTbc | 22.5 | mm |
| | Largest member distance | Lbc | 17.7 | mm |
| | Distance from largest member to emitting | Doc | 1.0 | mm |
| | surface of optical image transmitter | | | |
| | Threshold of full length of optical image | DTfc | 11.5 | mm |
| | transmitter | | | |
| | Full length of optical image transmitter | Dfc | 6.7 | mm |

The first image pickup unit 6a has the first optical fiber bundle 3a serving as the optical image transmitter, the first image sensor 4a, and the first driving substrate 5a.

It is set that the largest member is the driving substrate 5a also in the first image pickup unit 6a of the present embodiment. It is set here that a distance from the center of the incident surface 31a of the optical fiber bundle 3a to the largest member 5a in the direction of the central axis 7a is Lba, and a length of an optical fiber which transmits light from the center of the incident surface 31a (length of the optical fiber bundle 3a) in the direction of the central axis 7a is Dfa. In addition, it is set that the distance from the largest member 5a to the emitting surface 32a of the optical fiber bundle 3a in the direction of the central axis 7a is Doa, a width of the largest member 5a is Wba, and a largest member threshold is LTba.

In the present embodiment, with respect to the largest member threshold LTba=22.5 mm, the distance Lba=23.0 mm is provided. That is, the distance Lb is set to be longer than the largest member threshold LTb in the first image pickup unit 6a.

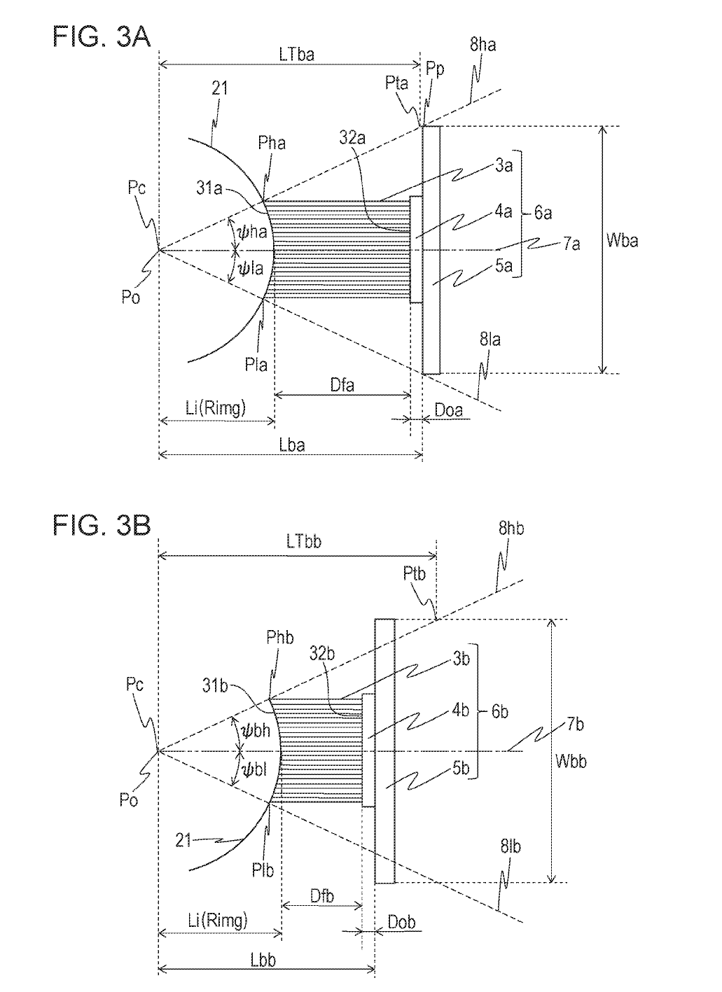

Moreover, by providing the length Dfa of the optical fiber bundle 3a=12.0 mm, the length Dfa is set to be longer than the threshold of the length of the optical image transmitter (optical image transmitter threshold) DTfa=11.5 mm, which is obtained with the formula (6) (FIG. 3A).

The second image pickup unit 6b is composed of the second optical fiber bundle 3b, the second image sensor 4b, and the second driving substrate 5b.

Also in the second image pickup unit 6b of the present embodiment, it is set that a distance from the center of the incident surface 31b of the optical fiber bundle 3b to the largest member 5b in the direction of the central axis 7b is Lbb, and a length of an optical fiber, which transmits light from the center of the incident surface 31b, in the direction of central axis 7b is Dfb. In addition, it is set that the distance from the largest member 5b to the emitting surface 32b of the optical fiber bundle 3b in the direction of the central axis 7b is Dob, the width of the largest member 5b is Wbb, and a largest member threshold is LTbb.

In the second image pickup unit 6b, the largest member threshold LTbb=22.5 mm and the largest member distance Lbb=17.7 mm are provided, and there is a relation expressed with the formula (1). That is, in the second image pickup unit 6b of the present embodiment, the largest member distance Lb is set to be shorter than the largest member threshold LTb.

Moreover, the length Dfb of the optical fiber bundle 3b=6.7 mm is provided, and the length Dfb is set to be shorter than a second optical image transmitter threshold DTfb=11.5 mm, thus making it possible to set the largest member distance Lb to be shorter than the largest member threshold LTb (FIG. 3B).

The third image pickup unit 6c has a configuration similar to that of the second image pickup unit 6b. Thus, a distance Lbc from the center of an incident surface 31c to a largest member 5c, a length Dfc of the optical fiber bundle 3c, a distance Doc from the largest member 5c to an emitting surface 32c, a width Wbc of the largest member 5c, and a largest member threshold LTc are respectively the same as those of the second image pickup unit 6b.

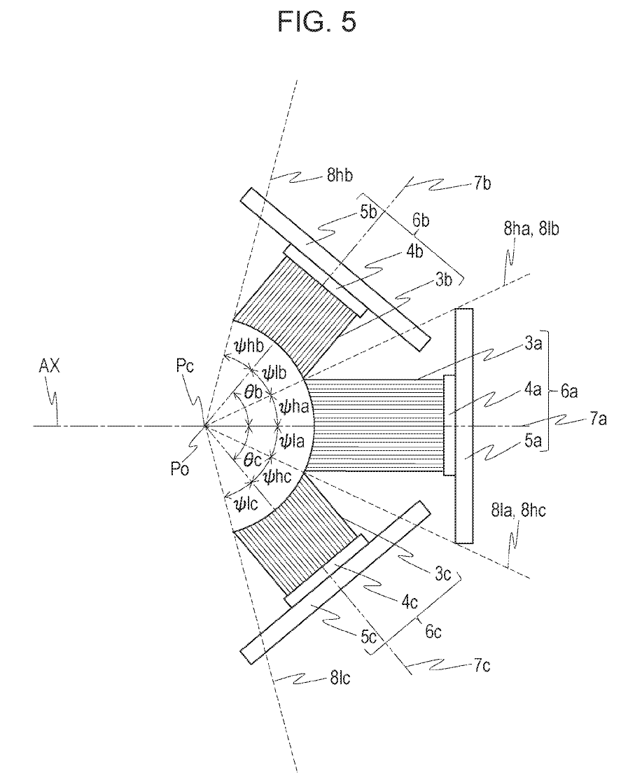

FIG. 5 illustrates arrangement of the three image pickup units 6a, 6b, and 6c in the imaging apparatus of the present embodiment. The first image pickup unit 6a is arranged so that the central axis 7a is on the optical axis AX of the imaging optical system 2. The second image pickup unit 6b is arranged so that the angle θb formed between the central axis 7b and the optical axis AX is +50.0 deg. Moreover, the third image pickup unit 6c is arranged so that an angle θc formed between a central axis 7c and the optical axis AX is −50.0 deg.

As to the image pickup units 6a, 6b, and 6c, it is possible to draw region boundary lines 8ha and 8la, 8hb and 8lb, and 8hc and 8lc, which connect the original point Po (Pc) and end points Pha and Pla, Phb and Plb, and Phc and Plc of the incident surfaces 31a, 31b, and 31c, respectively. At this time, the region boundary line 8ha coincides with the region boundary line 8lb, and the region boundary line 8la coincides with the region boundary line 8hc. As illustrated in FIG. 5, the driving substrate 5b of the second image pickup unit 6b and the driving substrate 5c of the third image pickup unit 6c protrude from the region boundary lines 8ha (8lb) and 8la (8hc), respectively, and are arranged also in a region of the first image pickup unit 6a. Note that, region boundary angles Ψha, Ψhb, and Ψhc are +25.0 deg, and region boundary angles Ψla, Ψlb, and Ψlc are −25.0 deg.

In order to realize the above, in the present embodiment, as to adjacent image pickup units, the respective central axes 7a and 7b of the image pickup units 6a and 6b are arranged so as to have different angles with respect to the optical axis AX. Moreover, it is set that the respective lengths Dfa and Dfb of the optical fiber bundles 3a and 3b in the adjacent image pickup units 6a and 6b are mutually different. The first image pickup unit 6a and the third image pickup unit 6c are also set so as to have a similar relation.

Specifically, the three image pickup units 6a, 6b, and 6c are arranged to have the rotation angles of θa=0.0 deg, θb=+50.0 deg, and θc=−50.0 deg with respect to the optical axis AX of the imaging optical system 2, respectively. In addition, the first optical fiber bundle 3a is set to satisfy the length Dfa=12.0 mm, and the second and third optical fiber bundles 3b and 3c are set to satisfy the lengths Dfb=6.7 mm and the length Dfc=6.7 mm, respectively. That is, full lengths of the respective optical fiber bundles of the adjacent image pickup units are different.

With such a configuration, it is possible to accommodate the driving substrates 5b and 5c, which are the largest members in the image pickup units 6b and 6c in each of which the full length of the optical fiber bundle is set to be short, in a space (gap) including the region of the image pickup unit 6a in which the full length of the optical fiber bundle is set to be long. Thereby, arrangement by utilizing a small space efficiently and preventing physical interference is realized.

In addition, since it is possible to shorten a length of each optical fiber to be used compared with a case where all of the lengths of the optical fiber bundles 3a, 3b, and 3c are set to be the same, it is possible to achieve a reduction in costs by manufacturing the optical fiber bundles at a moderate price. In the present embodiment, it is possible to shorten the length of the optical fiber bundle by 44% compared with a case where image pickup units are arranged so that largest members are in contact with region boundary lines.

### Embodiment 2

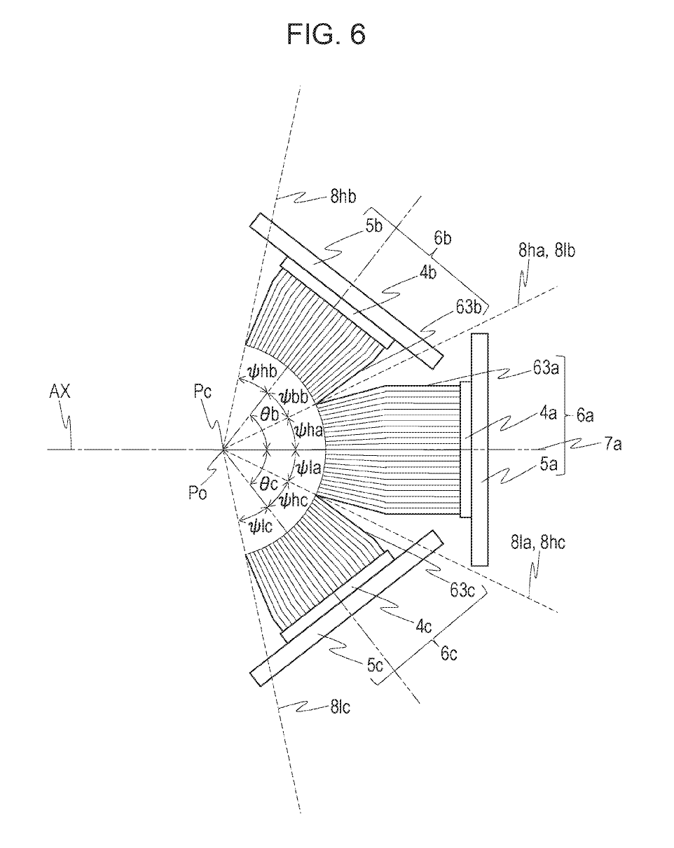

An imaging apparatus 61 of the present embodiment will be described with reference to FIG. 6. FIG. 6 is a schematic view for explaining configurations of the image pickup units 6a, 6b, and 6c of the imaging apparatus 61 of the present embodiment. The image pickup units 6a, 6b, and 6c of the present embodiment has tapered optical fiber bundles 63a, 63b, and 63c instead of the three optical image transmitters 3a, 3b, and 3c of the imaging apparatus 1 of Embodiment 1. In each of the tapered optical fiber bundles 63a, 63b, and 63c, a diameter of an incident surface is smaller than a diameter of an emitting surface. Since the other configurations are similar to those of Embodiment 1, detailed description thereof will be omitted. Lengths of optical fibers, each of which is closest to the center of the incident surface of the optical fiber bundles 63a, 63b, or 63c of each of the image pickup units 6, in directions which are respectively parallel to the optical fibers are different between adjacent image pickup units also in the imaging apparatus 61.

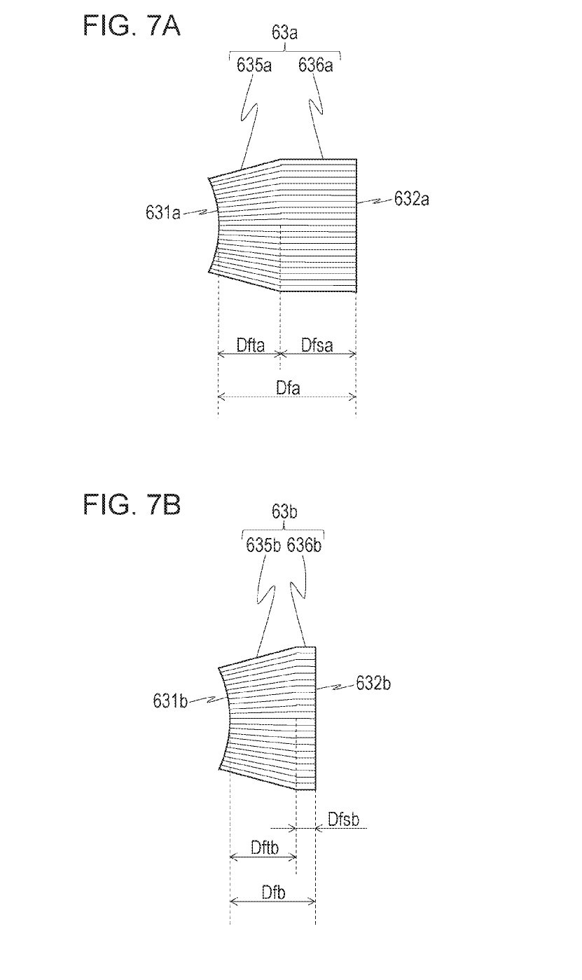

Each of configurations of the optical fiber bundles 63a, 63b, and 63c are described with reference to FIG. 7A and FIG. 7B. The configuration of each of the optical fiber bundles 63a, 63b, and 63c is indicated in Table 2. FIG. 7A is a configuration view of the optical fiber bundle 63a, and FIG. 7B is a configuration view of the optical fiber bundle 63b.

TABLE 2

| | | | | |
|---|---|---|---|---|
| Imaging | Focal distance | f | 10.0 | mm |
| optical | Curvature radius of image surface | Rimg | 10.0 | mm |
| system | | | | |
| First | Distance from original point of image | Lia | 10.0 | mm |
| image | pickup unit to incident surface of optical | | | |
| pickup | image transmitter | | | |
| unit | Rotation angle of image pickup unit | θa | 0.0 | deg |
| | Width of driving substrate | Wba | 21.0 | mm |
| | Width of optical image transmitter | Wfa | 13.2 | mm |
| | Distance from largest member to emitting | Doa | 1.0 | mm |
| | surface of optical image transmitter | | | |
| | Region boundary angle (upper end) | ψah | +26.0 | deg |
| | Region boundary angle (lower end) | ψal | −26.0 | deg |
| | Largest member distance threshold | LTba | 21.5 | mm |
| | Largest member distance | Lba | 23.0 | mm |
| | Threshold of full length of optical image | DTfa | 10.5 | mm |
| | transmitter | | | |
| | Full length of optical image transmitter | Dfa | 12.6 | mm |
| | Length of tapered part of optical fiber | Dfta | 5.6 | mm |
| | bundle | | | |
| | Length of straight part of optical fiber | Dfsa | 7.0 | mm |
| | bundle | | | |
| Second | Distance from original point of image | Lib | 10.0 | mm |
| image | pickup unit to incident surface of optical | | | |
| pickup | image transmitter | | | |
| unit | Rotation angle of image pickup unit | θb | +52.0 | deg |
| | Width of driving substrate | Wbb | 21.0 | mm |
| | Width of optical image transmitter | Wfb | 13.2 | mm |
| | Distance from largest member to emitting | Dob | 1.0 | mm |
| | surface of optical image transmitter | | | |
| | Region boundary angle (upper end) | ψbh | +26.0 | deg |
| | Region boundary angle (lower end) | ψbl | −26.0 | deg |
| | Largest member distance threshold | LTbb | 21.5 | mm |
| | Largest member distance | Lbb | 17.7 | mm |
| | Threshold of full length of optical image | DTfb | 10.5 | mm |
| | transmitter | | | |
| | Full length of optical image transmitter | Dfb | 7.2 | mm |
| | Length of tapered part of optical fiber | Dftb | 5.6 | mm |
| | bundle | | | |
| | Length of straight part of optical fiber | Dfsb | 1.6 | mm |
| | bundle | | | |
| Third | Distance from original point of image | Lic | 10.0 | mm |
| image | pickup unit to incident surface of optical | | | |
| pickup | image transmitter | | | |
| unit | Rotation angle of image pickup unit | θc | −52.0 | deg |
| | Width of driving substrate | Wbc | 21.0 | mm |
| | Width of optical image transmitter | Wfc | 13.2 | mm |
| | Distance from largest member to emitting | Doc | 1.0 | mm |
| | surface of optical image transmitter | | | |
| | Region boundary angle (upper end) | ψch | +26.0 | deg |
| | Region boundary angle (lower end) | ψ/cl | −26.0 | deg |
| | Largest member distance threshold | LTbc | 21.5 | mm |
| | Largest member distance | Lbb | 17.7 | mm |
| | Threshold of full length of optical image | DTfc | 10.5 | mm |
| | transmitter | | | |
| | Full length of optical image transmitter | Dfc | 7.2 | mm |
| | Length of tapered part of optical fiber | Dftc | 5.6 | mm |
| | bundle | | | |
| | Length of straight part of optical fiber | Dfsc | 1.6 | mm |
| | bundle | | | |

As illustrated in FIG. 7A, the optical fiber bundle 63a has a tapered part (first light guide part) 635a of an enlargement type, which enlarges an optical image and is arranged on an incident surface 631a side, and a straight part (second light guide part) 636a which is arranged on an image sensor 4a side (emitting surface 632a side) of the tapered part 635a. Similarly, the optical fiber bundle 63b also has a tapered part 635b of the enlargement type which is arranged on an incident surface 631b side and a straight part 636b which is arranged on an image sensor 4b side (emitting surface 632b side) of the tapered part 635b (FIG. 7B).

The tapered part 635b of the second optical fiber bundle 63b has the same configuration as that of the tapered part 635a of the first optical fiber bundle 63a. On the other hand, the straight part 636b of the second optical fiber bundle 63b is set to be shorter than the straight part 636a of the first optical fiber bundle 63a. Accordingly, the second optical fiber bundle 63b is to be shorter than the first optical fiber bundle 63a. The optical fiber bundle 63c has a configuration similar to that of the optical fiber bundle 63b.

A length Dfa of the optical fiber bundle 63a is 12.6 mm, and a length Dfb of the optical fiber bundle 63b is 7.2 mm. That is, the length Dfb of the optical fiber bundle 63b is about 57% of the length Dfa of the optical fiber bundle 63a. The optical image transmitter threshold DTfa=DTfb=10.5 mm is provided. Thus, it is set that the optical fiber bundle 63a is longer than the optical image transmitter threshold DTfa, and the optical fiber bundle 63b is shorter than the optical image transmitter threshold DTfb. Moreover, the optical fiber bundle 63c is also set to be shorter than the optical image transmitter threshold DTfc. In this manner, by setting the lengths of the optical fiber bundle 63a and the optical fiber bundle 63b which are adjacent to be different, it is possible to efficiently arrange the driving substrates 5a and 5b in a small space without physical interference with each other. A full length of the shorter optical fiber bundle can be equal to or less than 70% of a full length of the longer optical fiber bundle.

As in the present embodiment, a maximum width of the tapered optical fiber bundle may be used for a width Wf of the optical image transmitter in the tapered optical fiber bundle, and the width Wfa of the optical image transmitter of the optical fiber bundle 63a=13.2 mm and a width Wfb of the optical image transmitter of the optical fiber bundle 63b=13.2 mm are provided.

As illustrated in FIG. 6, with respect to the optical axis AX, the three image pickup units 6a, 6b, and 6c of the present embodiment are arranged so as to have rotation degrees of θa=0.0 deg, θb=+52.0 deg, and θc=−52.0 deg, respectively. Upper-side region boundary angles of the image pickup units 6a, 6b, and 6c are set so as to satisfy Ψah=Ψbh=Ψch=+26.0 deg, and lower-side ones are set so as to satisfy Ψal=Ψbl=Ψcl=−26.0 deg.

The optical fiber bundles 63a, 63b, and 63c of the present embodiment changes optical image transmission distances by changing lengths of straight parts thereof. Specifically, respective lengths of the tapered parts 635a, 635b, and 635c of the optical fiber bundles 63a, 63b, and 63c satisfy Dfta=Dftb=Dftc=5.6 mm, and, with respect to the length of the straight part 636a of the optical fiber bundle 63a, which satisfies Dfsa=7.0 mm, the length of the straight part 636b of the optical fiber bundle 63b satisfies Dfsb=1.6 mm. Similarly, the length of the straight part 636c of the optical fiber bundle 63c also satisfies Dfsc=1.6 mm. In this manner, as to the respective optical fiber bundles 63a, 63b, and 63c, it is set that the lengths of the tapered parts 635a, 635b, and 635c are equal and the lengths of the straight parts 636a, 636b, and 636c are different. With such a configuration, longitudinal and lateral widths of the optical fiber bundles are able to be uniform among the respective image pickup units 6a, 6b, and 6c, so that it is possible to use image sensors of the same type as the sensors 4a, 4b, and 4c.

Moreover, since deterioration in a light amount due to absorption by the optical fiber bundles is very little, change in the light amount is hardly caused even when the lengths of the optical fiber bundles are different. When image sensors are different, there are some cases where sizes and pixel sizes of the image sensors become different and change in characteristics of sensitivity or characteristics of noise is caused. According to the present embodiment, it is possible to reduce the change in the characteristics of sensitivity or the characteristics of noise. In addition, it is possible to reduce nonuniformity of brightness or noise, which is in accordance with a place. Thereby, it is possible to acquire an image having a higher image quality from divided images acquired by divided image pickup.

Though the example in which the tapered optical fiber bundle includes the tapered part and the straight part and these parts of each of the optical fibers are contiguous has been described in the present embodiment, there is no limitation thereto, and one which is obtained by bonding a tapered optical fiber bundle and a straight optical fiber bundle may be used, for example. At this time, a length of a tapered part may be the length of the tapered optical fiber bundle and a length of a straight part may be the length of the straight optical fiber bundle.

### Embodiment 3

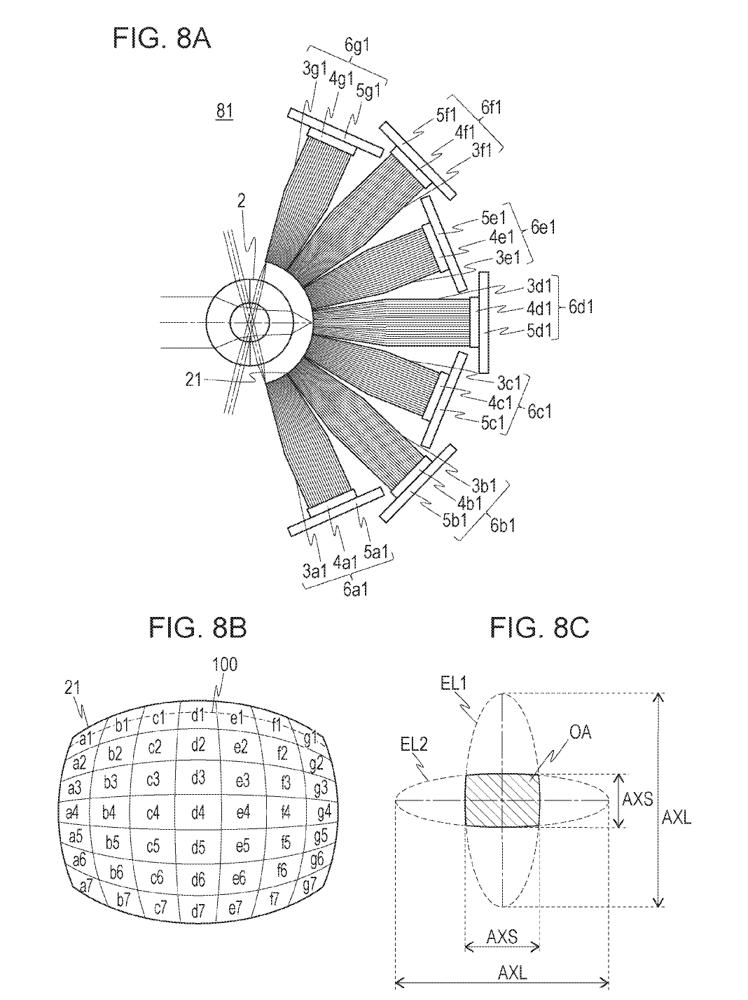

An imaging apparatus 81 of the present embodiment will be described. The imaging apparatus 81 is different from the above-described embodiments in that an optical image formed on the image surface 21 is divided into regions composed of 7×7 pieces, in which seven pieces are longitudinally arrayed and seven pieces are laterally arrayed, to be captured. Here, in the case of dividing the image surface 21 into 7×7 pieces, it is set that longitudinal arrays are a column a, a column b, . . . from the left as columns, and lateral arrays are a first row, a second row, . . . from the top as rows. A position of each of the regions is expressed by using these columns and rows. For example, a region which is the fourth from the left and the fourth from the top in FIG. 8B is a region d4. The imaging apparatus 81 has 7×7 image pickup units in order to capture each of the 7×7 regions. A configuration of each of the image pickup units is indicated in Table 3.

TABLE 3

| | | | | |
|---|---|---|---|---|
| Imaging | Focal distance | f | 20.0 | mm |
| optical | Curvature radius of image surface | Rimg | 20.0 | mm |
| system | | | | |
| Image | Array of image pickup units | | 7 × 7 | pieces |
| pickup | Distance from original point of image | Li | 20.0 | mm |
| unit | pickup unit to incident surface of | | | |
| | optical image transmitter | | | |
| | Lateral pitch of rotation angle of | | 22.0 | deg |
| | image pickup unit | | | |
| | Longitudinal pitch of rotation angle | | 16.5 | deg |
| | of image pickup unit | | | |
| | Width of driving substrate | Wb | 31.9 | mm |
| | Distance from largest member to | Do | 2.9 | mm |
| | emitting surface of optical image | | | |
| | transmitter | | | |
| | Region boundary angle (upper end) | ψh | +11.0 | deg |
| | Region boundary angle (lower end) | ψl | −11.0 | deg |
| Image | Largest member distance threshold | LTb | 82.1 | mm |
| pickup | Largest member distance | Lb | 72.0 | mm |
| unit | Threshold of full length of optical | DTf | 78.9 | mm |
| whose | image transmitter | | | |
| optical | Full length of optical image | Df | 49.1 | mm |
| fiber | transmitter | | | |
| bundle is | Length of tapered part of optical | Dft | 23.1 | mm |
| longer | fiber bundle | | | |
| | Length of straight part of optical | Dfs | 25.9 | mm |
| | fiber bundle | | | |
| Image | Largest member distance threshold | LTb | 82.1 | mm |
| pickup | Largest member distance | Lb | 64.6 | mm |
| unit | Threshold of full length of optical | DTf | 78.9 | mm |
| whose | image transmitter | | | |
| optical | Full length of optical image | Df | 41.7 | mm |
| fiber | transmitter | | | |
| bundle is | Length of tapered part of optical | Dft | 23.1 | mm |
| shorter | fiber bundle | | | |
| | Length of straight part of optical | Dfs | 18.6 | mm |
| | fiber bundle | | | |

FIG. 8A is a schematic view of a cross-section of the imaging apparatus 81 along a curved line 100 of FIG. 8B. FIG. 8A illustrates image pickup units 6a1 to 6g1, which captures regions a1 to g1, respectively, among the 7×7 image pickup units. The image pickup units 6a1 to 6g1 have optical fiber bundles 3a1 to 3g1, sensors 4a1 to 4g1, and driving substrates 5a1 to 5g1, respectively. Each of the optical fiber bundles 3a1 to 3g1 is an optical fiber bundle having a tapered part of the enlargement type, and constituted by the tapered part and a straight part. The respective image pickup units 6a1 to 6g1 have configurations similar to those of the image pickup units 6a to 6c of Embodiment 2, except that lengths of the optical fiber bundles are different.

Here, in the optical fiber bundle 3b1, a length of the tapered part Dft=23.1 mm and a length of the straight part Dfs=25.9 mm are satisfied. Moreover, in the optical fiber bundle 3a1, a length of the tapered part Dft=23.1 mm and a length of the straight part Dfs=18.6 mm are satisfied. That is, the optical fiber bundle 3a1 of the image pickup unit 6b1 is shorter than the optical fiber bundle 3b1. Among the plurality of image pickup units 6a1 to 6g1, lengths of the optical fiber bundles 3c1, 3e1, and 3g1 of the image pickup units 6c1, 6e1, and 6g1 are the same as that of the optical fiber bundle 3a1. In addition, lengths of the optical fiber bundles 3d1 and 3f1 of the image pickup units 6d1 and 6f1 are the same as that of the optical fiber bundle 3b1.

As above, in the adjacent image pickup units, the lengths of the optical fiber bundles are different also in the present embodiment. The image pickup units whose lengths of the optical fiber bundles are different are arranged alternately so that the image pickup units whose lengths of the optical fiber bundles are the same do not become adjacent. Specifically, among the plurality of regions, the lengths of the optical fiber bundles of the image pickup units which capture regions in even number-th rows of the column a, the column c, the column e, and the column g are set to be the same as that of the optical fiber bundle 6b1, and the lengths of the optical fiber bundles of the image pickup units which capture regions in odd number-th rows of these columns are set to be the same as that of the optical fiber bundle 6a1. Then, among the plurality of regions, the lengths of the optical fiber bundles of the image pickup units which capture regions in even number-th rows of the column b, the column d, and the column f are set to be the same as that of the optical fiber bundle 6a1, and the lengths of the optical fiber bundles of the image pickup units which capture regions in odd number-th rows of these columns are set to be the same as that of the optical fiber bundle 6b1.

In the present embodiment as well, the largest member of each of the image pickup units is the driving substrate, and, by setting the lengths of the optical fiber bundles of the adjacent image pickup units to be different, a space in which the image pickup units are arranged is reduced compared with a conventional one. Thereby, miniaturization of the whole imaging apparatus is realized.

The lengths of the optical fiber bundles are changed by setting the lengths of the tapered parts to be equal and setting the lengths of the straight parts to be different also in the present embodiment.

Note that, in a case where the image surface 21 is divided into seven in a longitudinal direction and seven in a lateral direction, incident surfaces of the respective image pickup units are arranged on the image surface 21 with no gap. At this time, the incident surface of each of the image pickup units can be set as follows. FIG. 8C illustrates a shape of the incident surface of each of the 7×7 image pickup units.

The incident surface of each of the 7×7 image pickup units is an overlap area OA when two ellipses EL1 and EL2 each of which has a major axis AXL equal to twice the curvature radius of the image surface 21 and whose minor axes AXS are different from each other are arranged so as to be orthogonal with the centers thereof matched. With such a configuration, elliptic arcs of the adjacent incident surfaces overlap on a spherical surface of the image surface 21. It is thereby possible to arrange the incident surfaces with no gap. Further, by setting the overlap area OA in which two types of the ellipses EL1 and EL2, whose minor axes are different in the longitudinal direction and the lateral direction, overlap, it is possible to allow pixels of an image sensor whose longitudinal width and lateral width are different so as to provide as many valid pixels as possible.

The optical axis AX of the imaging optical system 2 passes through the center of the region d4. That is, an image pickup unit 6d4 (not illustrated) which captures the region d4 is arranged so that the optical axis AX passes through the center of the incident surface of the optical fiber bundle 3d4 of the image pick up unit 6d4. In addition, with the image pickup unit 6d4 in the center, the image pickup units are arranged at a pitch of a rotation angle of 22.0 deg in the lateral direction. Further, with the image pickup unit 6d4 in the center, the image pickup units are arranged at a pitch of a rotation angle of 16.5 deg in the longitudinal direction. It is thereby configured so that an aspect ratio of the image sensor coincides with laterally 4:longitudinally 3.

In the present embodiment, the optical image transmitter threshold DTf=78.9 mm is satisfied. With respect thereto, the optical fiber bundle 31 satisfies Df=49.1 mm, and the optical fiber bundle 32 satisfies Df=41.7 mm, so that the both are set to be shorter than the optical image transmitter threshold DTf. Therefore, it is desired that the optical fiber bundle 3a1 satisfies the formula (3) and the optical fiber bundle 3b1 satisfies the formula (2).

Though, in the case of setting the lengths of all of the optical fiber bundles to be the same, a full length of each of the optical fiber bundles is at least 78.9 mm, it is possible to substantially reduce the shorter length to be 41.7 mm and the longer length to be 49.1 mm in the present embodiment. In this manner, by setting the lengths of all of the optical fiber bundles to be shorter than the optical image transmitter threshold DTf, it is possible to substantially reduce a space in which the image pickup units are arranged, thus making it possible to realize miniaturization of the imaging apparatus. Further, by setting lengths of optical image transmitters of adjacent image pickup units to be different and to satisfy the formula (2) and the formula (3), it is possible to arrange the image pickup units without causing each member to physically interfere, even when the optical image transmission distances of all of the image pickup units are shorter than the optical image transmitter threshold DTf.

In an imaging apparatus in which image pickup units are two-dimensionally arrayed, optical image transmission distances of the image pickup units 6a1, 6g1, 6a7, and 6g7 which respectively capture the regions a1, g1, a7, and g7 which are positioned farthest from the region d4 including the center of the image surface 21 can be shorter than the optical image transmitter threshold DTf. With such a configuration, it is possible to more efficiently reduce the space.

### Embodiment 4

An imaging apparatus of the present embodiment is similar to those of the above-described embodiments in that the lengths of the optical fiber bundles 3 of the adjacent image pickup units 6 are different, but is different from those of the above-described embodiments in that there are three stages as to the lengths of the optical fiber bundles 3. Moreover, in the present embodiment, an optical image formed on the image surface 21 is divided into regions composed of 5×5 pieces, in which five pieces are longitudinally arrayed and five pieces are laterally arrayed, to be captured. Similarly to Embodiment 3, in the case of dividing the image surface 21 into 5×5 pieces, it is set that longitudinal arrays are a column a, a column b, . . . from the left as columns, and lateral arrays are a first row, a second row, . . . from the top as rows, also in this case. The imaging apparatus of the present embodiment has 5×5 image pickup units. The other configurations are similar to those of Embodiment 3.

In the present embodiment, the configurations are similar to those of Embodiment 3, except that 5×5 image pickup units, in which five pieces are longitudinally arrayed and five pieces are laterally arrayed, are included.

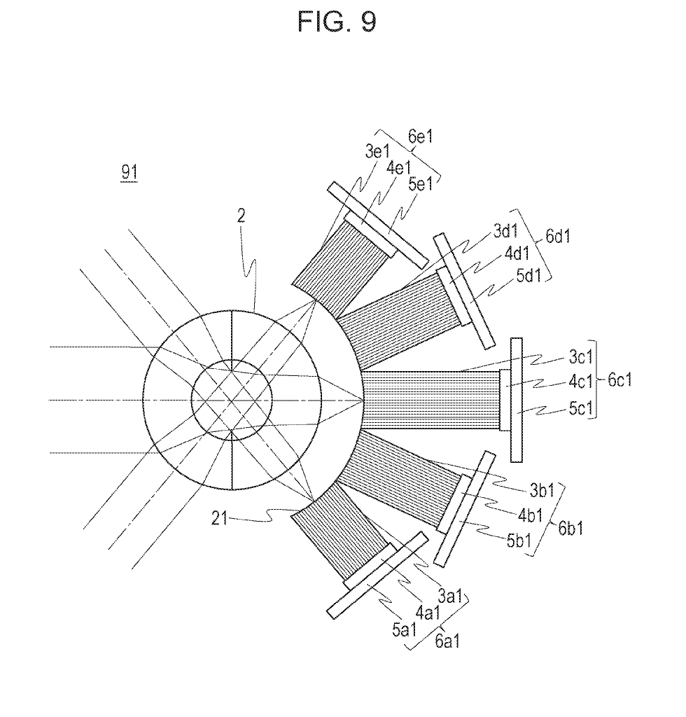

FIG. 9 is a schematic view for explaining the configuration of the imaging apparatus of the present embodiment, and illustrates the image pickup units 6a1 to 6e1 which capture the region a1 to e1, respectively. The image pickup units 6a1 to 6e1 have the optical fiber bundles 3a1 to 3e1, the sensors 4a1 to 4e1, and the driving substrates 5a1 to 5e1, respectively. Among them, the optical fiber bundles 3a1 and 3e1 are the shortest, and the optical fiber bundle 3c1 is the longest.

In this manner, lengths of optical fiber bundles of adjacent image pickup units are set to be different. With such a configuration, it is possible to reduce a space, in which a plurality of image pickup units are arranged, compared with a conventional one.

In addition, lengths of the optical fiber bundles 3a1, 3e1, 3a5, and 3e5 of the image pickup units 6a1, 6e1, 6a5, and 6e5 which respectively capture the regions a1, e1, a5, and e5 which are positioned farthest from the optical axis AX can be set to be shorter than that of an optical fiber bundle of each adjacent image pickup unit. It is thereby possible to more efficiently reduce the space in which the image pickup units are arranged.

Also in a projection apparatus which projects an image obtained by integrating images output from a plurality of display devices, it is possible to realize miniaturization of the projection apparatus with a simple configuration.

### Embodiment 5

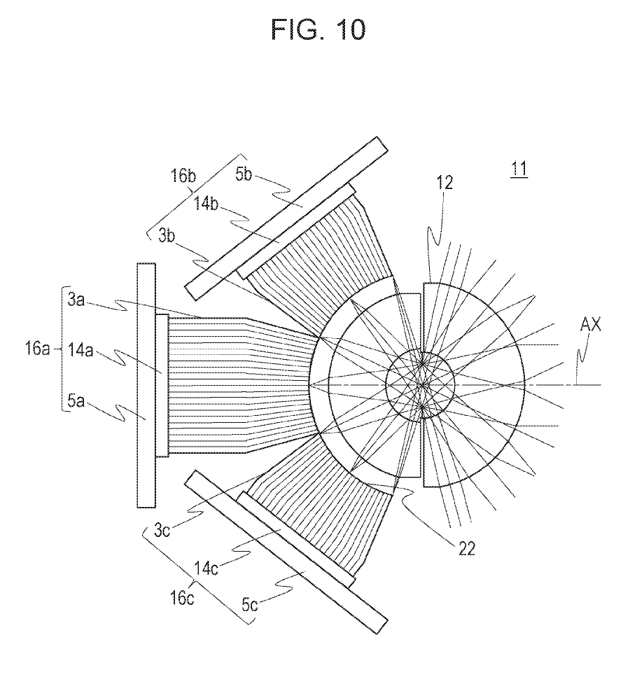

FIG. 10 illustrates a configuration view of a projection apparatus 11 of the present embodiment. The projection apparatus 11 has a form in which the configuration of the imaging apparatus 1 of Embodiment 2 is used in an opposite direction, and in which display devices are substituted for the image sensors 4. The projection apparatus 11 has three projection units 16a, 16b, and 16c and a projection optical system 12. The projection units 16a, 16b, and 16c have the optical image transmitters 3a, 3b, and 3c, display devices 14a, 14b, and 14c, and the driving substrates 5a, 5b, and 5c, respectively.

The projection apparatus 11 creates one image by integrating images displayed by the three projection units 16a, 16b, and 16c, and forms the image by the projection optical system 12 to project the image to a screen (not illustrated).

The respective images displayed by the three display devices 14a, 14b, and 14c are transmitted to an object surface 22, that is curved, of the projection optical system 12 by the optical image transmitters 3a, 3b, and 3c. The optical image transmitters 3a, 3b, and 3c are arranged so that sides of emitting surfaces 32a, 32b, and 32c are arranged with no gap therebetween along the object surface 22. Accordingly, the image projected to the object surface 22 is an image obtained by connecting the images respectively output from the display devices 16a, 16b, and 16c.

Similarly to Embodiment 2, between the optical image transmitters 3a and 3b, and 3a and 3c in adjacent display units, lengths of the optical image transmitters are set to be different also in the present embodiment. Specifically, the length of the optical image transmitter 3b is set to be shorter than the length of the optical image transmitter 3a. Moreover, the length of the optical image transmitter 3c is set to be shorter than the length of the optical image transmitter 3a.

According to the projection apparatus 11 of the present embodiment, it is thereby possible to reduce a space, in which the plurality of projection units 16a, 16b, and 16c are arranged, compared with a case where the lengths of all of the optical image transmitters are set to be equal. Thus, it is possible to arrange the projection units 16a, 16b, and 16c in a small space without causing each member to physically interfere.

As above, the suitable exemplary embodiments of the invention have been described. The imaging apparatus of the invention is usable for a product in which an imaging apparatus is used, such as a digital camera, digital video camera, a camera for a cellular phone, a monitoring camera, a medical camera, an image reading apparatus, or a fiber scope. Further, the projection apparatus of the invention is usable for a product in which a projection apparatus is used, such as a projector, a glass-like display, a head mounted display (HMD), a head-up display (HUD), or a viewer.

Though the suitable exemplary embodiments of the invention have been described as above, the invention is not limited to the exemplary embodiments, and various modifications and changes can be made within the scope of the invention. Though the number of types of the lengths of the optical fiber bundles is two or three in the above-described exemplary embodiments, setting of the lengths of the optical fiber bundles is not limited thereto, and a configuration in which the lengths of all of the optical fiber bundles are mutually different is allowed, for example.

Further, though the configuration in which an optical image transmitted by one optical fiber bundle is captured by one image sensor has been described in the above-described embodiments, there is no limitation thereto. For example, an optical image transmitted by one optical fiber bundle may be captured by a plurality of image sensors. In this case, a method of branching one optical fiber bundle, branching it according to wavelengths, or branching it according to light amounts may be used.

The image surface 21 of the imaging optical system 2 is not limited to be a spherical surface, and may be an aspherical surface. In this case, the center of curvature of a base spherical surface of the aspherical surface is defined as the center of curvature of the image surface 21 of the above-described embodiments. That is, the center of curvature of a spherical surface in a local region on the optical axis AX is set as the center of curvature of the image surface 21.

Furthermore, the imaging apparatus of each of the embodiments is able to sufficiently exhibit the effect of the invention also in the case of using an image pickup unit for infrared rays (whose wavelengths are 0.7 μm to 15 μm). At this time, an imaging optical system, an optical image transmitter, and an image sensor which are compatible with infrared rays may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-132144, filed on Jun. 30, 2015, which is hereby incorporated by reference herein in its entirety.

What is claimed is:

1. An imaging apparatus, comprising: an imaging optical system which forms an optical image of an object; and a plurality of image pickup units which capture the optical image of the object, wherein
each of the plurality of image pickup units has an image sensor and a light guide body which includes a plurality of optical waveguide members transmitting light from the imaging optical system to the image sensor,
an angle of a central axis of each of two adjacent image pickup units with respect to an optical axis of the imaging optical system is mutually different, and
an optical image transmission distance of each of the two adjacent image pickup units is mutually different.

2. The imaging apparatus according to claim 1, wherein an incident surface of the light guide body of each of the plurality of image pickup units has a concave shape which is directed toward an object side.

3. The imaging apparatus according to claim 1, wherein at least one of the two adjacent image pickup units satisfies a conditional equation (1) below,
$$Df < \frac{Wb}{tan ( \vert ψ h \vert ) + tan ( \vert ψ l \vert )} - Li - Do \qquad ( 1 )$$
Df: an optical image transmission distance of the one of the image pickup units,
Wb: a width of a largest member of the one of the image pickup units,
Ψh: an angle formed between a straight line, which connects a center of curvature of the imaging optical system and one end of the incident surface of the light guide body, and a central axis of the one of the image pickup units,
Ψl: an angle formed between a straight line, which connects the center of curvature and the other end of the incident surface, and the central axis of the one of the image pickup units,
Li: a distance from the center of curvature to the incident surface, and
Do: a distance from the largest member to an emitting surface of the light guide body.

4. The imaging apparatus according to claim 3, wherein all of the plurality of image pickup units satisfy the conditional equation (1).

5. The imaging apparatus according to claim 1, wherein, in a case where the two adjacent image pickup units are first and second image pickup units, an optical image transmission distance of the second image pickup unit is shorter than an optical image transmission distance of the first image pickup unit, and satisfies a conditional equation (2) below,
$$\frac{Wbb}{2 \times tan θ b} + \frac{Wfa}{2 \times sin θ b} - Lib - Dob < Dfb < \frac{Wbb}{tan ( \vert ψ hb \vert ) + tan ( \vert ψ lb \vert )} - Lib - Dob \qquad ( 2 )$$
Dfb: the optical image transmission distance of the second image pickup unit,
Wbb: a width of a largest member of the second image pickup unit,
Ψhb: an angle formed between a straight line, which connects a center of curvature of the imaging optical system and one end of an incident surface of a light guide body of the second image pickup unit, and a central axis of the second image pickup unit,
Ψlb: an angle formed between a straight line, which connects the center of curvature and the other end of the incident surface, and the central axis of the second image pickup unit,
Lib: a distance from the center of curvature to the incident surface,
Dob: a distance from the largest member to an emitting surface of the light guide body of the second image pickup unit,
θb: an angle formed between the optical axis of the imaging optical system and the central axis of the second image pickup unit, and
Wfa: a width of a light guide body of the first image pickup unit.

6. The imaging apparatus according to claim 1, wherein, in a case where the two adjacent image pickup units are first and second image pickup units, an optical image transmission distance of the first image pickup unit is longer than an optical image transmission distance of the second image pickup unit, and satisfies a conditional equation (3) below,
$$\frac{Lib + Dfb + Dob}{cos θ b} - \frac{Wfa \times tan θ b}{2} - Lia < Dfa \leq \frac{Wfa}{2 \times tan ( \vert ψ ha \vert )} - Lia - Doa \qquad ( 3 )$$
Lia: a distance from a center of curvature of the imaging optical system to an incident surface of a light guide body of the first image pickup unit,
Lib: a distance from the center of curvature to an incident surface of a light guide body of the second image pickup unit,
Dfa: the optical image transmission distance of the first image pickup unit,
Dfb: the optical image transmission distance of the second image pickup unit,
Doa: a distance from a largest member of the first image pickup unit to an emitting surface of the light guide body of the first image pickup unit,
Dob: a distance from a largest member of the second image pickup unit to an emitting surface of the light guide body of the second image pickup unit,
θb: an angle formed between a central axis of the second image pickup unit and the optical axis of the imaging optical system,
Wfa: a width of the light guide body of the first image pickup unit, and
Ψha: an angle formed between a central axis of the first image pickup unit and a straight line which connects the center of curvature and an end point of the incident surface of the light guide body of the first image pickup unit, which is on a side of the second image pickup unit.

7. The imaging apparatus according to claim 5, wherein the incident surface of the light guide body of the second image pickup unit is arranged at a position farthest from the optical axis of the imaging optical system among the plurality of image pickup units.

8. The imaging apparatus according to claim 5, wherein the optical image transmission distance of the second image pickup unit is the shortest among the plurality of image pickup units.

9. The imaging apparatus according to claim 1, wherein the light guide body of each of the plurality of image pickup units includes a first light guide part in which a diameter of an incident surface is smaller than a diameter of an emitting surface and a second light guide part in which a diameter of an incident surface is same as a diameter of an emitting surface.

10. The imaging apparatus according to claim 9, wherein a length of the second light guide part of each of the two adjacent image pickup units is mutually different.

11. The imaging apparatus according to claim 1, wherein an image surface of the imaging optical system has a concave shape which is directed toward an object side.

12. A projection apparatus, comprising: a plurality of projection units which display an image; and a projection optical system which forms the image, wherein
each of the plurality of projection units has a display device and a light guide body which includes a plurality of optical waveguide members transmitting light from the display device to the projection optical system,
an angle of a central axis of each of two adjacent projection units with respect to an optical axis of the projection optical system is mutually different, and
an optical image transmission distance of each of the two adjacent projection units is mutually different.

13. The projection apparatus according to claim 12, wherein an emitting surface of the light guide body of each of the plurality of projection units has a concave shape which is directed toward an optical image side.
